(19) United States
(12) Patent Application Publication
(10) Pub. No.: US 2019/0274308 A1
(43) Pub. Date: Sep. 12, 2019

(54) METHOD FOR PROTECTING PLANTS FROM PESTS USING A PESTICIDE COMPOSITION WITH ADJUSTABLE PERSISTENCE AND DEGRADABILITY

(71) Applicant: Flechsig Patent Company LLC, Cham (CH)

(72) Inventors: Frank FLECHSIG, Wohlen (CH); Thomas FLECHSIG, Edlibach (CH)

(21) Appl. No.: 16/338,069

(22) PCT Filed: Sep. 22, 2017
(86) PCT No.: PCT/EP2017/074090

§ 371 Date: Mar. 29, 2019

(30) Foreign Application Priority Data
Sep. 30, 2016 (EP) 16002114.3

(51) Int. Cl. A01N 47/44

(52) U.S. Cl. CPC A01N 47/44

(57) ABSTRACT

The invention relates to a method for protecting plants from pests, in particular bacteria, fungi, and viruses, using a pesticide composition with adjustable persistence and degradability, having the following steps: providing a pesticide composition which comprises at least one poly(alkyl)guanidine with a monomer alkyl chain length ranging from C₂ to C₂₀ and a degree of polymerization n ranging from 2 to 600, and applying the pesticide composition to plant cultures for a specified time and in sufficient quantities in order to prevent or inhibit an adversive effect of the pests on the plants, wherein the length of the monomer alkyl chain and/or the degree of polymerization are set depending on at least one characterizing parameter of the soil or nutrient medium in which the plants are cultivated such that a specified or desired persistence and degradability of the pesticide composition on the cultures or in the soil or nutrient medium are obtained. In a special embodiment of the method according to the invention, the at least one characterizing parameter of the soil or nutrient medium is determined in a first step, and the parameter is preferably selected from the pH value, the humus content, the humin content, the content of microorganisms, the content of soil fungi, or the content of soil bacteria.

### BACKGROUND OF THE INVENTION

Traditionally a broad spectrum of chemical compounds has been used to protect plants, in particular cultivated plants, from various pathogens.

These compounds should on the one hand display the highest possible effectiveness against one or more plant pests and on the other hand have the lowest possible toxicity for humans and animals. In many cases it is difficult to reconcile these demands. Moreover, in particular in the last few years, the permitted limits for pesticide residues in the soil have been lowered worldwide owing to increased environmental concerns and further restrictions can be expected.

It is difficult to respond to this trend with conventional pesticides. Farmers will be forced either to reduce drastically the quantities applied and/or the frequency of application and thus accept a drop in effectiveness and an increased risk of resistances or to move over to more readily degradable plant protection products. The latter are however not available with comparable effectiveness for all pathogens and/or their use involves increased costs.

Against this background the object of the present invention is to provide an improved method for protection from plant pests, in which the persistence and degradability of the pesticide composition can be adapted relatively easily and flexibly to the particular requirements without significantly impairing the effectiveness of the pesticide composition.

This object is achieved according to the invention with the method according to claim 1, in which a poly(alkyl)guanidine-based pesticide composition is used and the alkyl chain length of the particular monomer and/or the degree of polymerization of the polymer is varied in a targeted way depending on known or determined characteristic soil properties, in order to achieve a specified or desired persistence and degradability of the pesticide in this soil.

Additional aspects and more specific embodiments of the invention are subject matter of the further claims.

### DESCRIPTION OF THE INVENTION

Within the framework of extensive investigations by the inventors it was found that the availability (persistence) and degradability of poly(alkyl)guanidines (also referred to alternatively in the literature as poly(alkylene)guanidines) in a soil or nutrient medium, in which plants are to be cultivated, depend on the one hand on structural parameters of the particular poly(alkyl)guanidine, in particular the length of the alkyl(ene) chain of the particular base monomer and the degree of polymerization (number of monomer units in the molecule) of the polymer, and on the other hand on various characteristic parameters of the soil or nutrient medium and that a desired availability and degradability of a poly(alkyl)guanidine-based pesticide composition in a designated soil or nutrient medium can be obtained through targeted setting or selection of the alkyl monomer chain length and/or the degree of polymerization.

Accordingly one aspect of the invention relates to a method for protecting plants against plant pests, in particular bacteria, fungi and viruses, wherein the method comprises the provision of a pesticide composition, which comprises at least one poly(alkyl)guanidine with an alkyl chain length of the particular monomer ranging from C₂ to C₂₀ and a degree of polymerization n ranging from 2 to 600, and application of the pesticide composition to plant cultures, wherein the application comprises the direct application on the plants and/or the application on or in the soil or nutrient medium, for a specified time and in sufficient quantities in order to prevent or inhibit an adverse effect of the pests on the plants, wherein the length of the monomer alkyl chain and/or the degree of polymerization are set depending on at least one characterizing parameter of the soil or nutrient medium in which the plants are cultivated, such that a specified or desired persistence and degradability of the pesticide composition on the cultures (on the plants or in the soil or nutrient medium) are obtained.

A more specific embodiment of this method comprises at least the following steps:

a) determining at least one characterizing parameter of the soil or nutrient medium in which the plants are cultivated,
b) providing a pesticide composition which comprises at least one poly(alkyl)guanidine with an alkyl(ene) chain length of the particular monomer ranging from C₂ to C₂₀ and a degree of polymerization n ranging from 2 to 600,
and applying the pesticide composition to plant cultures, wherein the application comprises the direct application on the plants and/or the application on or in the soil or nutrient medium, for a specified time and in sufficient quantities in order to prevent or inhibit an adverse effect of the pests on the plants, wherein the length of the monomer alkyl chain and/or the degree of polymerization are set depending on at least one characterizing parameter of the soil or nutrient medium that was determined in step a), such that a specified or desired persistence and degradability of the pesticide composition on the cultures/cultivated plants or in the soil or nutrient medium are obtained.

The terms “persistence” or “availability”, as used herein, relate to the period in which a sufficiently large quantity of the pesticide is present on cultures (i.e. on the cultivated plants and/or on/in the soil or nutrient medium), in order to display the desired activity, i.e. elimination or inhibition of the growth of the particular phytopathogen.

The desired or specified persistence/availability of the pesticide in the soil can depend on various factors, in particular the species of the plant to be protected, the species of the phytopathogen, the time of year, the application etc. Typically the target persistence lies in the range from 3 to 30 days, e.g. less than 5 days, 10 days, 15 days, 20 days, 25 days.

The terms “degradability” and “degradation time”, as used here, relate to a substantially complete degradation of the pesticide, i.e. in the case of poly(alkyl)guanidine the monomers are then also degraded.

Typically the pesticide should be degraded within a period of 10 to 60 days, in particular within 20 or 21 days, 30 days or 50 days.

The at least one characterizing parameter of the soil or nutrient medium influences or determines the persistence and degradability of a poly(alkyl)guanidine in this soil or nutrient medium and can be for example the pH value, the humus content, the content of humic substances, the content of soil microorganisms, the content of soil bacteria and/or the content of soil fungi.

Preferably at least 2, 3 or 4 characterizing parameters of the soil or nutrient medium are used to set the pesticide composition.

The poly(alkyl)guanidines used according to the invention can be produced through polycondensation of guanidinium salts, e.g. guanidine hydrochloride, with aliphatic diamines of specified chain length (number of carbon and methylene units in the molecule) according to methods that are known in principle. The resulting polymers can be homopolymers or copolymers, depending on whether a single or various diamine monomer(s) are involved in the reaction.

The term “the monomer”, as used here, can refer to the single monomer of a homopolymer or to all monomers of a copolymer.

The at least one poly(alkyl)guanidine (or poly(alkylene) guanidine) of the pesticide composition used according to the invention has an alkyl chain length of the monomer or of the monomers (or of the corresponding repeat units in the polymer molecule) in the range from C₂-C₂₀, e.g. C₄-C₁₄, C₄-C₁₂, C₄-C₁₆, C₆-C₁₀, C₆-C₁₂, C₈-C₁₂, C₈-C₂₀, C₁₂-C₂₀ or C₁₄ to C₂₀, and a degree of polymerization n in the range from 2 to 600, preferably 5 to 300 or 5 to 200.

In a preferred embodiment the particular monomer has an even-numbered alkyl chain in the length range from C₂ to C₁₂, preferably C₆ or C₈ to C₁₀ or C₁₂, and the degree of polymerization lies in the range from 2 to 600, preferably 5 to 300 or 5 to 200.

In another preferred embodiment the monomer has an even-numbered alkyl chain in the length range from C₁₂ to C₂₀, preferably C₁₄ to C₂₀ or C₁₂ to C₁₈, and the degree of polymerization lies in the range from 2 to 400, preferably 5 to 260.

The at least one poly(alkyl)guanidine of the pesticide composition used according to the invention typically has a molecular weight ranging from 200 to 100,000 dalton, preferably 1,000 to 40,000 dalton, in particular 1,000 to 10,000 dalton.

As mentioned already above, one characteristic soil parameter is the pH value of the soil or nutrient medium. The pH value varies typically in a range from 3.0 to 8.5.

Table 1 below indicates the typical pH values for various soil types and shows the degradation times of various exemplary poly(alkyl)guanidines (poly(hexamethylene)guanidine (PHMG); poly(tetramethylene)guanidine (PTMG); poly(octamethylene)guanidine (POMG)) at these pH values.

TABLE 1

| pH | Days C6 | Days C4 | Days C8 | |
|---|---|---|---|---|
| value | PHMG | PTMG | POMG | Soil type |
| 4.5 | 16 | 14 | 21 | Coniferous forest, heath soils |
| 5 | 15 | 11 | 19 | Sandy soils with humus |
| 6.5 | 14 | 10 | 17 | Sandy loam with humus |
| 7 | 15 | 12 | 18 | Clay loam with humus |
| 7.5 | 16 | 14 | 20 | Loess soil with humus |
| 8 | 18 | 16 | 23 | Limy soil, deciduous forest |

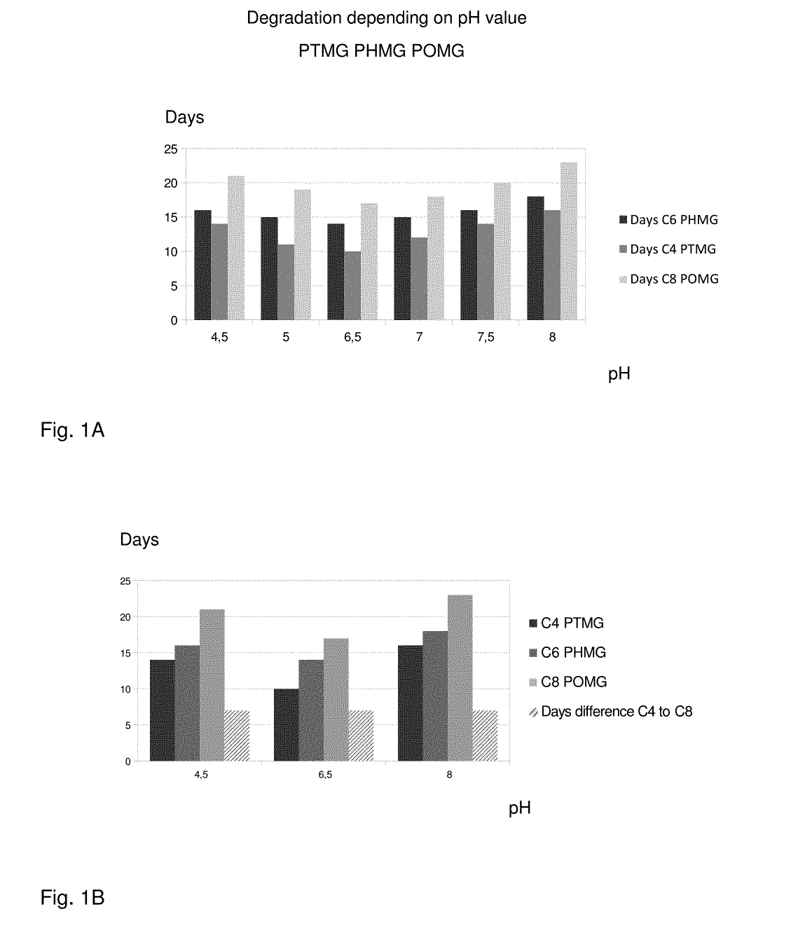

In FIG. 1 the degradation times are represented in graph form for PTMG, PHMG and POMG at various pH values and the differences are highlighted visually.

A specific embodiment of the method for plant protection according to the invention relates to a method, in which the alkyl chain length of the particular monomer and the degree of polymerization n are selected depending on the pH value, such that the following conditions are satisfied:

for a pH value ranging from 3.0 to 4.2 the alkyl chain length of the particular monomer lies in the range from C₂ to C₁₄ and n lies in the range from 5 to 100;
for a pH value ranging from 4.21 to 5.8 the alkyl chain length of the particular monomer lies in the range from C₂ to C₁₈ and n lies in the range from 5 to 220;
for a pH value ranging from 5.81 to 7.8 the alkyl chain length of the particular monomer lies in the range from C₂ to C₂₀ and n lies in the range from 5 to 255;
for a pH value ranging from 7.81 to 8.2 the alkyl chain length of the particular monomer lies in the range from C₂ to C₁₈ and n lies in the range from 5 to 180;
for a pH value ranging from 8.21 to 8.5 the alkyl chain length of the particular monomer lies in the range from C₂ to C₁₄ and n lies in the range from 5 to 100.

A further characterizing parameter of the soil is the humus content. The term “humus” means basically the total content of organic substances (i.e. content of nutrient humus+stable humus) and can be determined as described in Example 1.

The proportion of humus in the soil varies typically in a range from 0.2% to 50%.

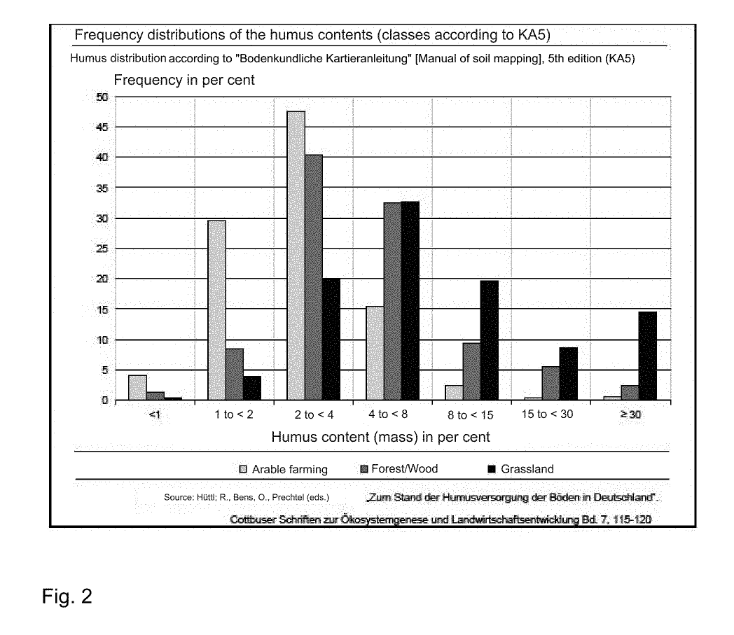

FIG. 2 indicates the typical proportions of humus for various soil types and Table 2 below shows the degradation times of exemplary poly(alkyl)guanidines (poly(hexamethylene)guanidine (PHMG); poly(tetramethylene)guanidine (PTMG); poly(octamethylene)guanidine (POMG)) with various proportions of humus.

TABLE 2

| Proportion of humus | Days | | |
|---|---|---|---|
| in % | C6 PHMG | Days C4 PTMG | Days C8 POMG |
| 0.5 | 30 | 20 | 40 |
| 1 | 25 | 16 | 36 |
| 1.5 | 20 | 13 | 28 |
| 2 | 15 | 10 | 22 |
| 4 | 14 | 8 | 18 |
| 8 | 12 | 6 | 17 |
| 15 | 10 | 5 | 15 |
| 30 | 7 | 4 | 14 |

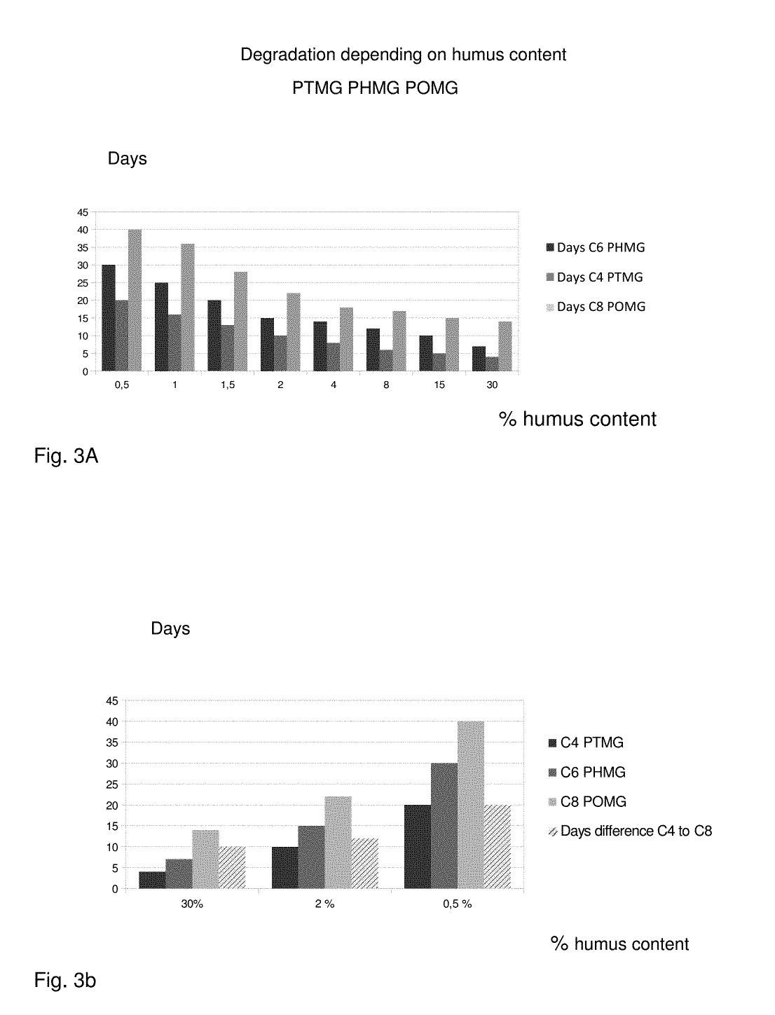

In FIG. 3 the degradation times are represented in graph form for PTMG, PHMG and POMG with various humus contents and the differences are highlighted visually.

A specific embodiment of the method for plant protection according to the invention relates to a method, in which the alkyl chain length of the particular monomer and the degree of polymerization n are selected depending on the humus content, such that the following conditions are satisfied:

for a humus content ranging from 0.2% to 2% the alkyl chain length of the particular monomer lies in the range from C₂ to C₁₄ and n lies in the range from 5 to 140;
for a humus content ranging from 2.01% to 5% the alkyl chain length of the particular monomer lies in the range from C₂ to C₁₄ and n lies in the range from 5 to 160;
for a humus content ranging from 5.01% to 10% the alkyl chain length of the particular monomer lies in the range from C₂ to C₁₄ and n lies in the range from 5 to 180;
for a humus content ranging from 15.01% to 25% the alkyl chain length of the particular monomer lies in the range from C₂ to C₁₈ and n lies in the range from 5 to 220;
for a humus content ranging from 25.01% to 50% the alkyl chain length of the particular monomer lies in the range from C₂ to C₂₀ and n lies in the range from 5 to 255.

A further characterizing soil parameter is the content of humic substances. The humic-substance content varies typically in a range from 0.2% to 25%.

Table 3 below indicates the typical proportions of humic substances for various soil types and shows the degradation times of exemplary poly(alkyl)guanidines (poly(hexamethylene)guanidine (PHMG); poly(tetramethylene)guanidine (PTMG); poly(octamethylene)guanidine (POMG)) with these proportions of humic substances.

TABLE 3

| | Days | | | |
|---|---|---|---|---|
| Proportion of | C6 | Days C4 | Days C8 | |
| humin in % | PHMG | PTMG | POMG | Soil representative |
| 0.5 | 25 | 22 | 35 | Sandy soil |
| 1 | 22 | 19 | 31 | Arable soil |
| 2 | 20 | 15 | 25 | Arable soil |
| 4 | 15 | 12 | 21 | Black earth |
| 8 | 13 | 9 | 18 | Chernozem meadow soil |
| 16 | 10 | 6 | 15 | Moorland soils |

Table 4 shows the different degradation times with selected proportions of humic substances.

TABLE 4

| | | | | Days |
|---|---|---|---|---|
| | | | | difference |
| Soil parameter | C4 PTMG | C6 PHMG | C8 POMG | C4 to C8 |
| Humic substances 16% | 6 | 10 | 15 | 9 |
| Humic substances 2% | 15 | 20 | 25 | 10 |
| Humic substances 0.5% | 22 | 25 | 35 | 13 |

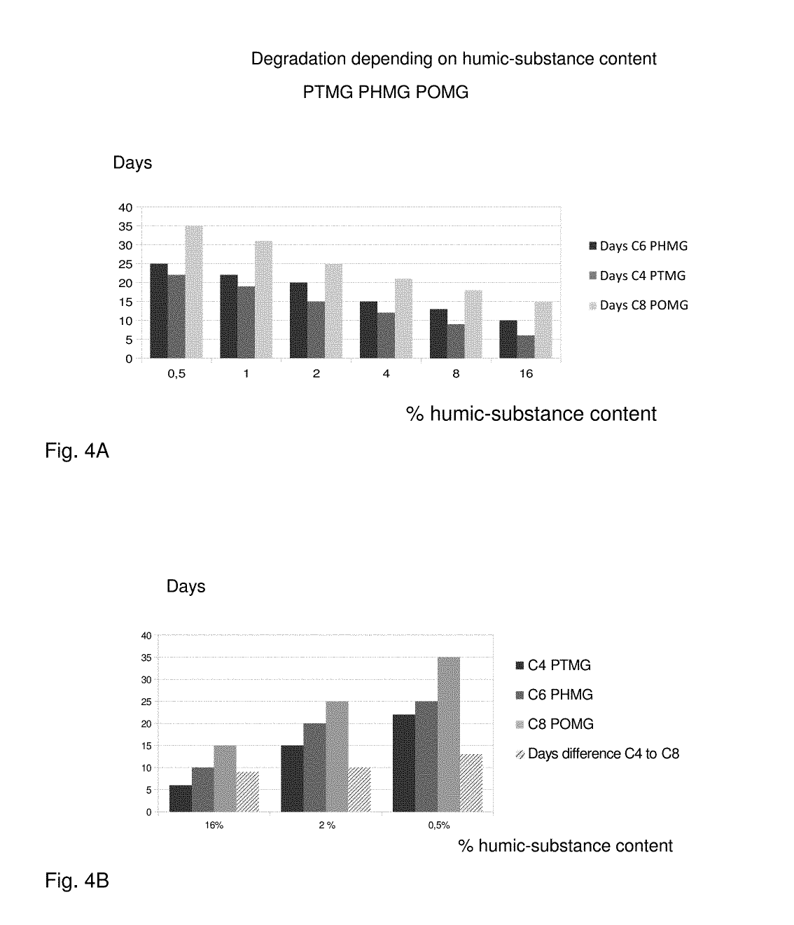

In FIG. 4 the degradation times are represented in graph form for PTMG, PHMG and POMG with various humic-substance contents and the differences are highlighted visually.

A specific embodiment of the method for plant protection according to the invention relates to a method, in which the molecular weight of the at least one poly(alkyl)guanidine and the degree of polymerization n are selected depending on the humic-substance content of the soil, such that the following conditions are satisfied:

for a humic-substance content ranging from 0.2% to 2% the molecular weight lies in the range from 600 to 37,500 dalton and n lies in the range from 5 to 100;
for a humic-substance content ranging from 2.01% to 5% the molecular weight lies in the range from 600 to 60,000 dalton and n lies in the range from 5 to 180;
for a humic-substance content ranging from 5.01% to 10% the molecular weight lies in the range from 600 to 37,500 dalton and n lies in the range from 5 to 200;
for a humic-substance content ranging from 10.01% to 15% the molecular weight lies in the range from 600 to 82,500 dalton and n lies in the range from 5 to 220;
for a humic-substance content ranging from 15.01% to 25% the molecular weight lies in the range from 600 to 96,000 dalton and n lies in the range from 5 to 255.

A further characterizing parameter of the soil is the content of microorganisms, in particular bacteria, fungi and microfauna.

Tables 5 and 6 below indicate the degradation times of exemplary poly(alkyl)guanidines depending on various contents of microorganisms in the soil.

TABLE 5

| | | | | | |
|---|---|---|---|---|---|
| Classification | extremely low | low | normal | rich | very high |

C6 PHMG

| | | | | | |
|---|---|---|---|---|---|
| Bacteria (g/m²) | 2 | 20 | 160 | 300 | 500 |
| Fungi (g/m²) | 0.1 | 4 | 68 | 180 | 350 |
| Microfauna (g/m²) | 0.7 | 10 | 32 | 60 | 120 |
| Days | 45 | 35 | 25 | 20 | 15 |

C4 PTMG

| | | | | | |
|---|---|---|---|---|---|
| Bacteria (g/m²) | 2 | 20 | 160 | 300 | 500 |
| Fungi (g/m²) | 0.1 | 4 | 68 | 180 | 350 |
| Microfauna (g/m²) | 0.7 | 10 | 32 | 60 | 120 |
| Days | 32 | 27 | 20 | 17 | 10 |

C8 POMG

| | | | | | |
|---|---|---|---|---|---|
| Bacteria (g/m²) | 2 | 20 | 160 | 300 | 500 |
| Fungi (g/m²) | 0.1 | 4 | 68 | 180 | 350 |
| Microfauna (g/m²) | 0.7 | 10 | 32 | 60 | 120 |
| Days | 45 | 41 | 30 | 27 | 21 |

TABLE 6

| | | | | Days |
|---|---|---|---|---|
| | C4 | C6 | C8 | difference |
| Classification | PTMG | PHMG | POMG | C4 to C8 |
| B20/F4/M10 g/m² low | 32 | 45 | 57 | 25 |
| B160/F68/M32 g/m² medium | 20 | 25 | 30 | 10 |
| B500/F350/M120 g/m² high | 10 | 15 | 21 | 11 |
| B700/F1500/150 g/m² very high | <10 | <15 | <21 | not tested |

(bacteria = B/fungi = F/microfauna = M)

A specific embodiment of the method according to the invention

for protecting plants against plant pests comprises the provision of a pesticide composition, which comprises at least one poly(alkyl)guanidine with a monomer alkyl chain length ranging from C₂ to C₂₀ and a degree of polymerization n ranging from 2 to 600,
and application of the pesticide composition to plant cultures, wherein the application comprises the direct application on the plants and/or the application on or in the soil or nutrient medium, for a specified time and in sufficient quantities in order to prevent or inhibit an adverse effect of the pests on the plants, wherein the length of the monomer alkyl chain and/or the degree of polymerization are selected or set depending on at least one characterizing parameter of the soil or nutrient medium in which the plants are cultivated, such that a specified or desired persistence and degradability of the pesticide composition on the plants or in the soil or nutrient medium are obtained, and wherein the at least one characterizing soil parameter is selected from the group comprising a pH value ranging from 3.0 to 8.5, a content of humic substances ranging from 0.2% to 25%, a humus content ranging from 0.2 to 50%, a content of microorganisms ranging from 2 g/m² to 2,500 g/m², a content of soil bacteria ranging from 1 g/m² to 2,500 g/m², a content of soil fungi ranging from 1 g/m² to 2,500 g/m².

Table 7 below shows the degradation of the exemplary C₄-C₈-poly(alkyl)guanidines PTMG, PHMG, POMG in respective concentrations of 20 mg/l, which had been applied onto a base area of 0.25 m² of a test substrate (TerraSub PS018).

TABLE 7
Substrate TerraSub PS018 (mixture of topsoil,
compost and natural sand)

| | Days degradation of | | | | |
|---|---|---|---|---|---|
| | 20 mg/l on 0.25 m² | | | | |
| | 0 | 5 | 10 | 15 | 20 |
| PTMG C4 degradation % | 0 | 25 | 76 | 100 | 100 |
| PTMG C4 mg/l | 20 | 15 | 5 | 0 | 0 |
| PHMG C6 degradation % | 0 | 17 | 51 | 79 | 100 |
| PHMG C6 mg/l | 20 | 17 | 10 | 4 | 0 |
| POMG C8 degradation % | 0 | 13 | 38 | 59 | 75 |
| POMG C8 mg/l | 20 | 17 | 12 | 8 | 5 |

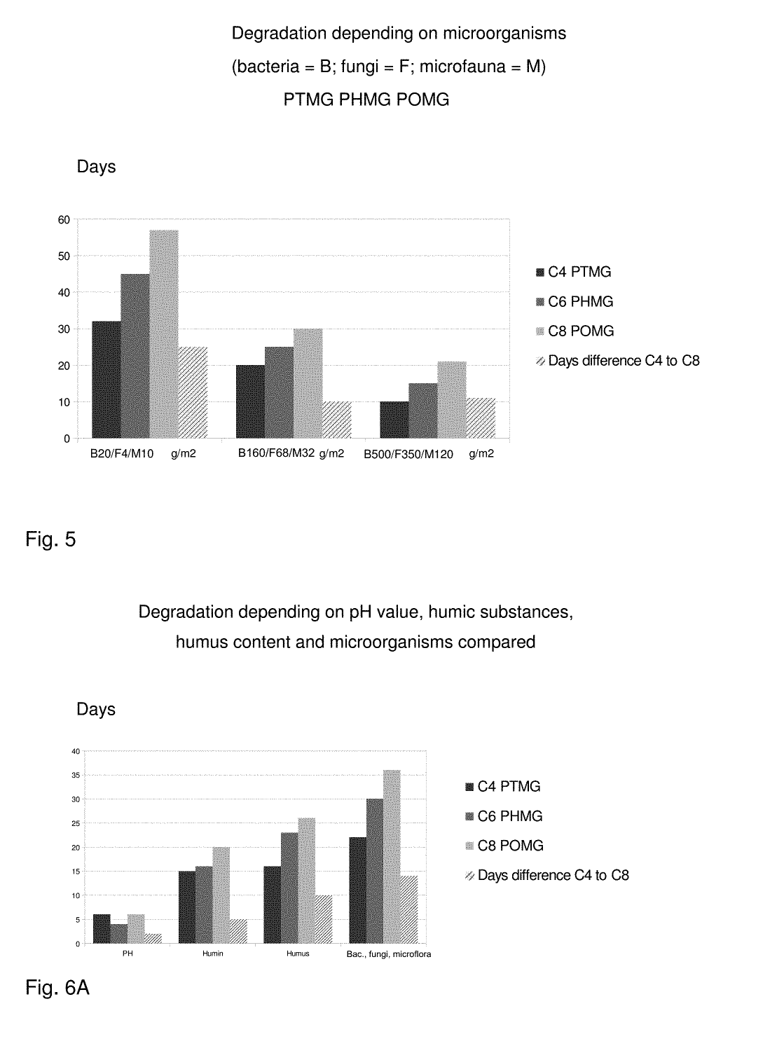

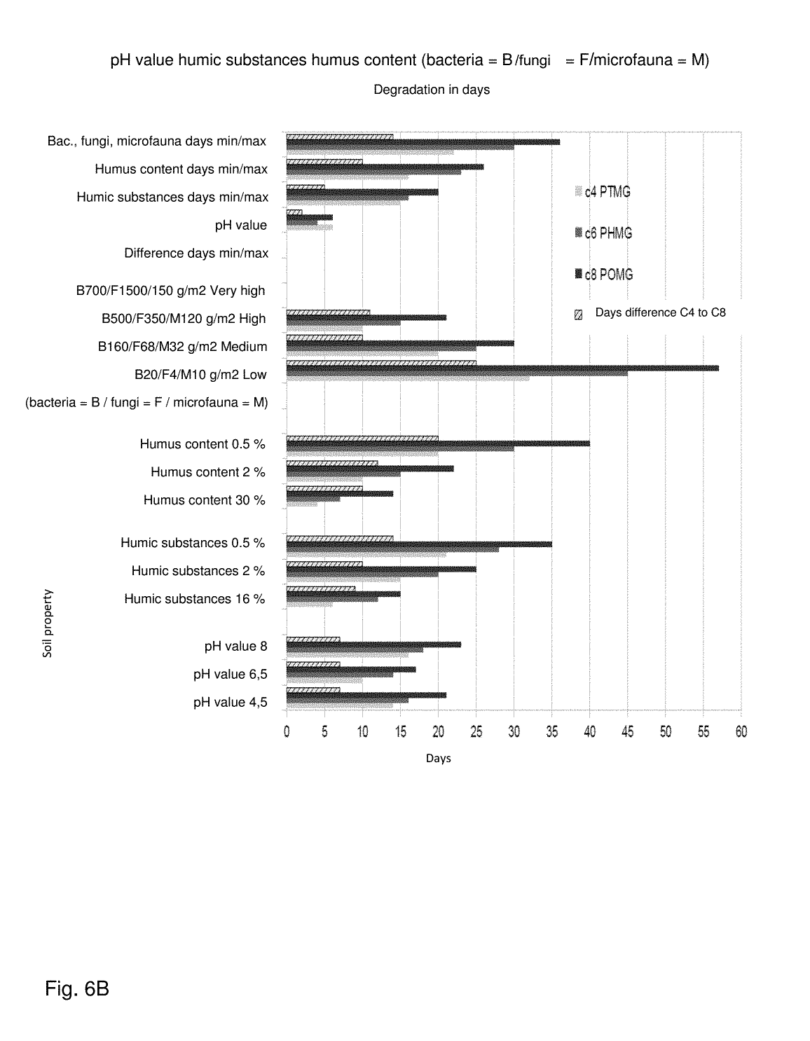

Table 8 below and FIG. 6A show the different degradation times as difference in days between minimum degradation time and maximum degradation time for the exemplary C₄-C₈-poly(alkyl)guanidines depending on various soil properties.

TABLE 8

| | | | | |
|---|---|---|---|---|
| | | | | Days |
| | C4 | C6 | C8 | difference |
| Difference days min/max | PTMG | PHMG | POMG | C4 to C8 |

Soil properties

| | | | | |
|---|---|---|---|---|
| pH value days min/max | 6 | 4 | 6 | 2 |
| Humic substances days min/max | 15 | 16 | 20 | 5 |
| Humus content days min/max | 16 | 23 | 26 | 10 |
| Bact., fungi, microfauna days | 22 | 30 | 36 | 14 |
| min/max | | | | |

Table 9 below and FIG. 6B show a summary of the influence of the afore-described soil properties/parameters on the degradation of the exemplary C₄-C₈-poly(alkyl)guanidines.

TABLE 9

| | | | | Days |
|---|---|---|---|---|
| | C4 | C6 | C8 | difference |
| Soil properties | PTMG | PHMG | POMG | C4 to C8 |
| pH value 4.5 | 14 | 16 | 21 | 7 |
| pH value 6.5 | 10 | 14 | 17 | 7 |
| pH value 8 | 16 | 18 | 23 | 7 |
| Humic substances 16% | 6 | 12 | 15 | 9 |
| Humic substances 2% | 15 | 20 | 25 | 10 |
| Humic substances 0.5% | 21 | 28 | 35 | 14 |
| Humus content 30% | 4 | 7 | 14 | 10 |
| Humus content 2% | 10 | 15 | 22 | 12 |
| Humus content 0.5% | 20 | 30 | 40 | 20 |

(bacteria = B/fungi = F/microfauna = M)

| | | | | |
|---|---|---|---|---|
| B20/F4/M10 g/m² Low | 32 | 45 | 57 | 25 |
| B160/F68/M32 g/m² Medium | 20 | 25 | 30 | 10 |
| B500/F350/M120 g/m² High | 10 | 15 | 21 | 11 |
| B700/F1500/150 g/m² Very high | <10 | <15 | <21 | not |
| | | | | determ. |

Difference days min/max

| | | | | |
|---|---|---|---|---|
| pH value | 6 | 4 | 6 | 2 |
| Humic substances days min/max | 15 | 16 | 20 | 5 |
| Humus content days min/max | 16 | 23 | 26 | 10 |
| Bact., fungi, microfauna days | 22 | 30 | 36 | 14 |
| min/max | | | | |

In the method according to the invention the at least one poly(alkyl)guanidine in the pesticide composition used is contained typically in an amount between 10 ppm and 200.000 ppm, preferably between 20 ppm and 40.000 ppm, of the overall composition (typically an aqueous composition).

The pesticide composition is applied typically at least once in a quantity of 100-5,000 l, preferably 500-1,500 l, per ha of soil or nutrient medium.

In the method according to the invention the at least one poly(alkyl)guanidine is typically the only component in the pesticide composition with pesticidal activity.

In a specific embodiment of the method according to the invention the pesticide composition used can however also comprise at least one further component, which displays action against plant pests. In this case the type and quantity of the second component are preferably selected, such that the persistence profile and/or degradation profile that is desired or is specified by the at least one poly(alkyl)guanidine is not impaired or not significantly impaired.

This component is preferably selected from the group of compounds comprising azoles, in particular diazoles, triazoles, benzimidazoles, and pyrazoles, carbamates, in particular benzimidazole carbamates and dithiocarbamates, carboxamides, dicarboximides, anilides, nicotinamides, amines and ammonium compounds, including spiroketal-amines and heterocyclic compounds like for example pyrimidines, pyridines, piperidines, morpholines, pyrroles, in particular phenyl pyrroles, diazines, strobulines and nitriles.

Because of the broad spectrum of action of the poly(alky)guanidines used the method according to the invention can be used on a broad variety of plant pests, in particular microorganisms such as bacteria, fungi and viruses. More specifically the plant pest is a representative from the group of phytopathogenic fungi, comprising Alternaria species, Aspergillus species, Blumeria species, Botrytis species, Ceratocystis species, Crinipellis species, Cephaleuros species, Colletotrichum species, Curvularia species, Erysiphaceae species, Fusaria species, Gloeosporium species, Glomerella species, Melampsora species, Mycosphaerella species, Moniliophthora species, Magnaporthe species, Odium species, Penicillium species, Plasmopara species, Puccinia species, Phakopsora species, Podosphaera species, Pythium species, Phytophora species, Setosphaeria species, Sclerophtora species, Ustilago species, Venturia species, Verticillium species; phytopathogenic bacteria, comprising Acetobacter species, Agrobacterium species, Clavibacter species, Candidatus liberibacter species, Curtobacterium species, Dickeya species, Erwinia species, Pantoea species, Pectobacterium species, Pseudomonas species, Ralstonia species, Xanthomonas species; and phytopathogenic viruses, comprising tobacco mosaic virus (TMV), tomato spotted wilt virus (TSWV), TYLCV (tomato yellow leaf curl virus), cucumber mosaic virus (CMV), potato virus Y (PVY), cauliflower mosaic virus (CaMV), African cassava mosaic virus (ACMV), plum pox virus (PPV), brome mosaic virus (BMV), BBTV (banana bunchy top nanovirus), BSV (banana streak badnavirus), barley yellow dwarf disease luteovirus complex, MSV (maize streak mastrevirus), maize dwarf mosaic potivirus, rice tungro disease virus complex, RYMV (rice yellow mottle sobemovirus), sugarcane mosaic potivirus, SPFMV (sweet potato feathery mottle potyvirus).

Even more specifically the plant pest is a representative of the group of phytopathogenic fungi, comprising Alternaria sp., Aspergillus flavus, Blumeria graminis, Botrytis cinerea, Botryodiplodia theobromae, Ceratocystis paradoxa, crinipellis, perniciosa, Cephaleuros spp., Colletotrichum gloeosporioides, Curvularia verucculosa, Erysiphaceae sp., Fusarium oxysporum, Fusarium graminearum, Fusarium oxysporum f. sp. Cubense type 1-4, Gloeosporium sp., Glomerella Tucumanensis, Melampsora lini, Mycosphaerella graminicola, Mycosphaerella musicola, Mycosphaerella fijiensis, Moniliophthora Roreri, Magnaporthe oryzae, Odium lycopersicum, Penicillium claviforme, Penicillium digitatum, Plasmopara viticola, Pucciniomycotina, Puccinia sorghi, Phakopsora meibomiae, Phakopsora pachyrizi, Podosphaera leucotricha, Podosphaera aphanis, Podosphaera pannosa, Pythium sp., Phytospora infestans, Phytophtora pod rot, Rhizopus stolonifer, Rhizopus oryzae, Setosphaeria turcica, Ustilago maydis, Verticillium alboatrum, Venturia inaequalis, Venturia carpophila; and phytopathogenic bacteria, comprising Acetobacter peroxydans, Acetobacter aceti, Agrobacterium tumefaciens, Clavibacter michiganensis, Clavibacter sepedonicus, Candidatus Liberibacter asiaticus, Curtobacterium flaccumfaciens, Dickeya dadantii, Dickeya solani, Erwinia ananas, Erwinia Amylovora, Pantoea agglomerans, Pectobacterium carotovorum, Pectobacterium atrosepticum, Pseudomonas syringae pathovars, Pseudomonas savastanoi, Ralstonia solanacearum, Xanthomonas oryzae, Xanthomonas campestris pathovars, Xanthomonas axonopodis pathovars, Xanthomonas oryzae, pv. oryzae.

A related aspect of the present invention relates to a method for the production or provision of a poly(alkyl)guanidine-based pesticide composition with a specified availability and/or degradability in a designated soil or nutrient medium, at least one characterizing parameter of which is known, said characterizing parameter influencing or determining the availability and/or degradability and being selected from the group comprising a pH value ranging from 3.0 to 8.5, a content of humic substances ranging from 0.2% to 25%, a humus content ranging from 0.2% to 50%, a content of microorganisms ranging from 2 g/m² to 2,500 g/m², a content of soil bacteria ranging from 1 g/m² to 2,500 g/m², a content of soil fungi ranging from 1 g/m² to 2,500 g/m².

In this method the length of the monomer alkyl chain and/or the degree of polymerization of at least one poly(alkyl)guanidine is selected or set, depending on this at least one characterizing parameter of the soil or nutrient medium, within a range of the alkyl chain length of the particular monomer from C₂ to C₂₀, preferably from C₄ to C₁₄ or C₁₆, and within a range of the degree of polymerization n from 2 to 600, preferably from 5 to 300, such that a specified or desired persistence and degradability of the pesticide composition in the soil or nutrient medium with this at least one characterizing parameter are obtained.

In a specific embodiment of this production method an even-numbered monomer alkyl chain in the length range from C₂ to C₁₂, preferably C₆ or C₈ to C₁₀ or C₁₂, is selected and the degree of polymerization lies in the range from 2 to 600, preferably 5 to 300 or 5 to 200.

In another preferred embodiment of this method the particular monomer has an even-numbered alkyl chain in the length range from C₁₂ to C₂₀, preferably C₁₄ to C₂₀ or C₁₂ to C₁₈, and the degree of polymerization lies in the range from 2 to 400, preferably 5 to 260.

A further aspect of the invention relates to a poly(alkyl)guanidine-based pesticide composition, obtainable with the above method, with a specified persistence and/or degradability in a designated soil or nutrient medium, at least one characterizing parameter of which is known, said characteristic parameter influencing or determining the persistence and/or degradability, said composition comprising at least one poly(alkyl)guanidine (homopolymer or copolymer) with a monomer alkyl chain length ranging from C₂ to C₂₀ and a degree of polymerization n ranging from 2 to 600 and/or with a molecular weight ranging from 200 to 100,000 dalton, preferably 1,000 to 40,000 dalton, in particular 1,000 to 10,000 dalton.

Table 10 below shows the solubilities of PHMG of different molecular weight (in dalton) in water and various alcohols.

TABLE 10

| | C6 PHMG | C6 PHMG | C6 PHMG | C6 PHMG |
|---|---|---|---|---|
| | 1,000 | 9,500 | 12,500 | 14,500 |
| Water | 520 | 468 | 433 | 371 |
| Methanol | 57.3 | 52.4 | 49.3 | 43.5 |
| Ethanol | 38.2 | 35.2 | 33.2 | 29.3 |
| Propanol | 19.1 | 17.5 | 16.5 | 14.5 |
| log Pow | −2.185 | −2.108 | −2.054 | −1.936 |

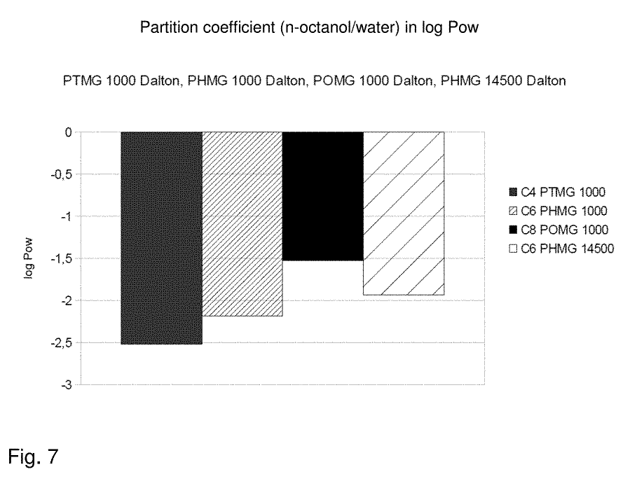

FIG. 7 and Table 11 below show the partition coefficient (n-octanol/water) in a log Pow shake test according to the standard test guideline OECD 107 for various exemplary polymers.

TABLE 11

| | C4 PTMG | C6 PHMG | C8 POMG | C6 PHMG |
|---|---|---|---|---|
| | 1,000 | 1,000 | 1,000 | 14,500 |
| Water | 624 | 520 | 417 | 371 |
| Octanol | 1.9 | 3.4 | 12.4 | 4.3 |
| log Pow | −2.516 | −2.185 | −1.527 | −1.936 |

The log P value is positive for lipophilic substances and negative for hydrophilic substances. Its particular level for the various polymers allows conclusions to be drawn in respect of the different bioaccumulation and the different degradability due to hydrolysis depending on the composition of the particular polymer and its degree of polymerization.

### Example 1

### Production of Defined Substrates and Measuring Methods

A. Production of at Least 20 kg Substrate with Exact Proportion of Humic Substances:
Sand 0-4 mm washed, Coop DIY superstore, 25 kg quantity, 3 packs
PERLHUMUS® Granules, Humintech GmbH, 25 kg, 1 pack

PERLHUMUS® Granules, based on soft brown coal, high proportion of leonardites, confirmed 60% content of humic acid complexes.

This material represents a very good basis for the production of substrates with humic substances in desired concentrations.

1 concentration 0.5%

| | Quantity kg | Humic-substance content % |
|---|---|---|
| PERLHUMUS ® Granules | 0.17 | 60 |
| Sand | 20 | 0 |
| Mixture 1 0.5% | 20.17 | 0.51 |

2 concentration 2%

| | Quantity kg | Humic-substance content % |
|---|---|---|
| PERLHUMUS ® Granules | 0.7 | 60 |
| Sand | 20 | 0 |
| Mixture 2 2% | 20.7 | 2.03 |

3 concentration 16%

| | Quantity kg | Humic-substance content % |
|---|---|---|
| PERLHUMUS ® Granules | 7.300 | 60 |
| Sand | 20 | 0 |
| Mixture 3 16% | 27.3 | 16.04 |

### B: Determination of Humus, Bacteria, Fungi, Microfauna

These determinations were obtained basically according to established methods, in particular as described in “Bodenbiologische Arbeitsmethoden”, 2nd revised and expanded edition, F. Schinner, E. Kandeler, R. Öhlinger, R. Margesin (eds.) (1993).

### Humus:

### Humus Determination by Means of Wet Oxidation According to E. Kandeler

### Principle

Potassium dichromate is reduced to Cr(III) by means of the organic substance of a soil. Cr(III) is determined colorimetrically and represents a measure of the humus content of a soil.

### Bacteria:

### Counting of Soil Bacteria by Means of Fluorescence Microscopy According to G. Trolldenier

### Principle

To determine the total bacterial count according to Trolldenier (1972), a soil suspension is applied onto a defined area of a slide and the dried soil film is stained with acridine orange. The bacterial count is determined in a plurality of counting fields under the fluorescence microscope and from this the total bacterial count of the soil sample is calculated.

### Fungi:

### Determination of the Fungal Biomass by Means of Determination of Ergosterol According to H. Rössner

### Principle

The ergosterol of the soil fungi is saponified with KOH, extracted with n-hexane in the separating funnel, dried at 40° C. in the rotary evaporator and then dissolved in methanol. Detection is achieved by means of HPLC at 282 nm. The procedure is based on the method of Zelles et al. (1987) and was modified in a few points.

### Microfauna:

### Determination of the Biomass of Microfauna

For the sake of simplicity calculation is performed using the dimensions of the dishes. At least 10 individuals per species should be measured. The resulting volume mean value can be equated numerically with the weight, as the specific mass of the microfauna is approximately 1 g cm⁻³.

1. A method for protecting plants against plant pests, said method comprising:
providing a pesticide composition, which comprises at least one poly(alkyl)guanidine with a monomer alkyl chain length ranging from C₂ to C₂₀ and a degree of polymerization n ranging from 2 to 600, and
application of the pesticide composition to plant cultures,
wherein the application comprises a direct application on the plants and/or the application on or in soil or a nutrient medium in which the plants are cultivated, for a specified time and in sufficient quantities in order to prevent or inhibit an adverse effect of the pests on the plants, wherein the alkyl chain length and/or the degree of polymerization are set depending on at least one characterizing parameter of the soil or nutrient medium in which the plants are cultivated, such that a specified or desired persistence and degradability of the pesticide composition on the plant cultures or in the soil or nutrient medium are obtained.

2. The method according to claim 1, further comprising at least the following steps:
a) determining the at least one characterizing parameter of the soil or nutrient medium in which the plants are cultivated, and
b) applying the pesticide composition to plant cultures, wherein the application comprises the direct application on the plants and/or the application on or in the soil or nutrient medium, for a specified time and in sufficient quantities in order to prevent or inhibit an adverse effect of the pests on the plants, and setting the length of the monomer alkyl chain and/or the degree of polymerization depending on the at least one characterizing parameter of the soil or nutrient medium that was determined in step a).

3. The method according to claim 1, wherein the at least one characterizing soil parameter of the soil is selected from the group consisting of a pH value ranging from 3.0 to 8.5, a content of humic substances ranging from 0.2% to 25%, a humus content ranging from 0.2% to 50%, a content of microorganisms ranging from 2 g/m² to 2,500 g/m², a content of soil bacteria ranging from 1 g/m² to 2,500 g/m², and a content of soil fungi ranging from 1 g/m² to 2,500 g/m².

4. The method according to claim 1, wherein at least 2 characterizing parameters of the soil or nutrient medium are determined or specified.

5. The method according to claim 1, wherein
the persistence of the pesticide lies within the range from 3 to 30 days, and/or the pesticide is degraded within a period of 10 to 60 days.

6. The method according to claim 1, in which the at least one poly(alkyl)guanidine has a molecular weight ranging from 200 to 100,000 dalton.

7. The method according to claim 1, in which a particular monomer of the at least one poly(alkyl)guanidine has an even-numbered alkyl chain in a length range from C₂ to C₁₂, and the degree of polymerization n lies in a range from 2 to 600.

8. The method according to claim 1, in which a particular monomer of the at least one poly(alkyl)guanidine has an even-numbered alkyl chain in a length range from C₁₂ to C₂₀, and the degree of polymerization n lies in a range from 2 to 400.

9. The method according to claim 1, in which the at least one poly(alkyl)guanidine in the pesticide composition is contained in an amount from 10 ppm to 200,000 ppm, an aqueous composition.

10. The method according to claim 1, in which the alkyl chain length of a particular monomer and the degree of polymerization n are selected depending on a pH value, such that the following conditions are satisfied:
for a pH value ranging from 3.0 to 4.2 the alkyl chain length of the particular monomer lies in a range from C₂ to C₁₄ and n lies in a range from 5 to 100;
for a pH value ranging from 4.21 to 5.8 the alkyl chain length of the particular monomer lies in the range from C₂ to C₁₈ and n lies in the range from 5 to 220;
for a pH value ranging from 5.81 to 7.8 the alkyl chain length of the particular monomer lies in the range from C₂ to C₂₀ and n lies in the range from 5 to 255;
for a pH value ranging from 7.81 to 8.2 the alkyl chain length of the particular monomer lies in the range from C₂ to C₁₈ and n lies in the range from 5 to 180; and
for a pH value ranging from 8.21 to 8.5 the alkyl chain length of the particular monomer lies in the range from C₂ to C₁₄ and n lies in the range from 5 to 100.

11. The method according to claim 1, in which the alkyl chain length of a particular monomer and the degree of polymerization n are selected depending on a humus content, such that the following conditions are satisfied:
for a humus content ranging from 0.2% to 2% the alkyl chain length of the particular monomer lies in the range from C₂ to C₁₄ and n lies in the range from 5 to 140;
for a humus content ranging from 2.01% to 5% the alkyl chain length of the particular monomer lies in the range from C₂ to C₁₄ and n lies in the range from 5 to 160;
for a humus content ranging from 5.01% to 10% the alkyl chain length of the particular monomer lies in the range from C₂ to C₁₄ and n lies in the range from 5 to 180;
for a humus content ranging from 15.01% to 25% the alkyl chain length of the particular monomer lies in the range from C₂ to C₁₈ and n lies in the range from 5 to 220; and
for a humus content ranging from 25.01% to 50% the alkyl chain length of the particular monomer lies in the range from C₂ to C₂₀ and n lies in the range from 5 to 255.

12. The method according to claim 1, in which a molecular weight of the at least one poly(alkyl)guanidine and the degree of polymerization n are selected depending on a humic-substance content of the soil, such that the following conditions are satisfied:
for a humic-substance content ranging from 0.2% to 2% the molecular weight lies in the range from 600 to 37,500 dalton and n lies in the range from 5 to 100;
for a humic-substance content ranging from 2.01% to 5% the molecular weight lies in the range from 600 to 60,000 dalton and n lies in the range from 5 to 180;
for a humic-substance content ranging from 5.01% to 10% the molecular weight lies in the range from 600 to 37,500 dalton and n lies in the range from 5 to 200;
for a humic-substance content ranging from 10.01% to 15% the molecular weight lies in the range from 600 to 82,500 dalton and n lies in the range from 5 to 220; and
for a humic-substance content ranging from 15.01% to 25% the molecular weight lies in the range from 600 to 96,000 dalton and n lies in the range from 5 to 255.

13. The method according to claim 1, in which a mixture of poly(alkyl)guanidines is used.

14. The method according to claim 1, in which the pesticide composition is applied at least once in a quantity of 100-5,000 l, per ha of soil or nutrient medium.

15. The method according to claim 1, in which the pesticide composition used also contains at least one further component that displays action against plant pests.

16. The method according to claim 15, in which the at least one further component that displays action against plant pests is selected from the group of compounds consisting of diazoles, triazoles, benzimidazoles, pyrazoles, benzimidazole carbamates, dithiocarbamates, carboxamides, dicarboximides, anilides, nicotinamides, amines, spiroketal-amines, pyrimidines, pyridines, piperidines, morpholines, phenyl pyrroles, diazines, strobulines and nitriles.

17. The method according to claim 1, in which the plant pest is: (a) phytopathogenic fungi selected from the group consisting of Alternaria species, Aspergillus species, Blumeria species, Botrytis species, Ceratocystis species, Crinipellis species, Cephaleuros species, Colletotrichum species, Curvularia species, Erysiphaceae species, Fusaria species, Gloeosporium species, Glomerella species, Melampsora species, Mycosphaerella species, Moniliophthora species, Magnaporthe species, Odium species, Penicillium species, Plasmopara species, Puccinia species, Phakopsora species, Podosphaera species, Pythium species, Phytophora species, Setosphaeria species, Sclerophtora species, Ustilago species, Venturia species, and Verticillium species; (b) phytopathogenic bacteria selected from the group consisting of Acetobacter species, Agrobacterium species, Clavibacter species, Candidatus liberibacter species, Curtobacterium species, Dickeya species, Erwinia species, Pantoea species, Pectobacterium species, Pseudomonas species, Ralstonia species, and Xanthomonas species; or (c) phytopathogenic viruses selected from the group consisting of tobacco mosaic virus (TMV), tomato spotted wilt virus (TSWV), TYLCV (tomato yellow leaf curl virus), cucumber mosaic virus (CMV), potato virus Y (PVY), cauliflower mosaic virus (CaMV), African cassava mosaic virus (ACMV), plum pox virus (PPV), brome mosaic virus (BMV), BBTV (banana bunchy top nanovirus), BSV (banana streak badnavirus), barley yellow dwarf disease luteovirus complex, MSV (maize streak mastrevirus), maize dwarf mosaic potivirus, rice tungro disease virus complex, RYMV (rice yellow mottle sobemovirus), sugarcane mosaic potivirus, and SPFMV (sweet potato feathery mottle potivirus).

18. The method according to claim 17, in which the plant pest is: (i) selected from phytopathogenic fungi selected from the group consisting of Alternaria sp., Aspergillus flavus, Blumeria graminis, Botrytis cinerea, Botryodiplodia theobromae, Ceratocystis paradoxa, crinipellis, perniciosa, Cephaleuros spp., Colletotrichum gloeosporioides, Curvularia verucculosa, Erysiphaceae sp., Fusarium oxysporum, Fusarium graminearum, Fusarium oxysporum f. sp. Cubense type 1-4, Gloeosporium sp., Glomerella Tucumanensis, Melampsora lini, Mycosphaerella graminicola, Mycosphaerella musicola, Mycosphaerella fijiensis, Moniliophthora Roreri, Magnaporthe oryzae, Odium lycopersicum, Penicillium claviforme, Penicillium digitatum, Plasmopara viticola, Pucciniomycotina, Puccinia sorghi, Phakopsora meibomiae, Phakopsora pachyrizi, Podosphaera leucotricha, Podosphaera aphanis, Podosphaera pannosa, Pythium sp., Phytospora infestans, Phytophtora pod rot, Rhizopus stolonifer, Rhizopus oryzae, Setosphaeria turcica, Ustilago maydis, Verticillium alboatrum, Venturia inaequalis, and Venturia carpophila; or (b) phytopathogenic bacteria selected from the group consisting of Acetobacter peroxydans, Acetobacter aceti, Agrobacterium tumefaciens, Clavibacter michiganensis, Clavibacter sepedonicus, Candidatus Liberibacter asiaticus, Curtobacterium flaccumfaciens, Dickeya dadantii, Dickeya solani, Erwinia ananas, Erwinia Amylovora, Pantoea agglomerans, Pectobacterium carotovorum, Pectobacterium atrosepticum, Pseudomonas syringae pathovars, Pseudomonas savastanoi, Ralstonia solanacearum, Xanthomonas oryzae, Xanthomonas campestris pathovars, Xanthomonas axonopodis pathovars, and Xanthomonas oryzae, pv. oryzae.

19. A method for providing a poly(alkyl)guanidine-based pesticide composition with a specified persistence and/or degradability in a designated soil or nutrient medium, at least one characterizing parameter of which is known, said characterizing parameter influencing or determining a persistence and/or a degradability and being selected from the group consisting of a pH value ranging from 3.0 to 8.5, a content of humic substances ranging from 0.2% to 25%, a humus content ranging from 0.2% to 50%, a content of microorganisms ranging from 2 g/m² to 2,500 g/m², a content of soil bacteria ranging from 1 g/m² to 2,500 g/m², and a content of soil fungi ranging from 1 g/m² to 2,500 g/m², and
wherein there is added to the pesticide composition at least one poly(alkyl)guanidine, in which a length of a monomer alkyl chain and/or a degree of polymerization is selected or set, depending on the at least one characterizing parameter of the soil or nutrient medium, within a range of the monomer alkyl chain length of a particular monomer from C₂ to C₂₀, and within a range of the degree of polymerization n from 2 to 600, such that a specified or desired persistence and degradability of the pesticide composition on cultures or in the soil or nutrient medium with the at least one characterizing parameter are obtained.

20. The method according to claim 19, in which at least one poly(alkyl)guanidine is added, which has an even-numbered monomer alkyl chain in the length range from C₂ to C₁₂, and the degree of polymerization of which lies in the range from 2 to 600.

21. The method according to claim 20, in which at least one poly(alkyl)guanidine is added, which has an even-numbered monomer alkyl chain in the length range from C₁₂ to C₂₀, and the degree of polymerization of which lies in the range from 2 to 400.

22. A poly(alkyl)guanidine-based pesticide composition with a specified persistence and/or degradability in a designated soil or nutrient medium, at least one characterizing parameter of which is known, said characteristic parameter influencing or determining a persistence and/or a degradability, wherein the composition is obtainable with the method according to claim 19 and comprises at least one poly(alkyl)guanidine homopolymer or copolymer with a monomer alkyl chain length ranging from C₂ to C₂₀ and a degree of polymerization n ranging from 2 to 600 and/or with a molecular weight ranging from 200 to 100,000 dalton.
